(19) United States
(12) Patent Application Publication
(10) Pub. No.: US 2012/0190372 A1
(43) Pub. Date: Jul. 26, 2012

(54) RF CONSIDERATIONS FOR USER EQUIPMENT HANDOFF

(75) Inventors: Brett Schein, San Jose, CA (US); Murari Srinivasan, Palo Alto, CA (US); Peter J. Worters, Menlo Park, CA (US); Amit Butala, Sunnyvale, CA (US)

(73) Assignee: SpiderCloud Wireless, Inc.

(21) Appl. No.: 13/355,391

(22) Filed: Jan. 20, 2012

Related U.S. Application Data
(60) Provisional application No. 61/435,745, filed on Jan. 24, 2011.

(51) Int. Cl. H04W 36/30

(52) U.S. Cl. 455/444

(57) ABSTRACT

A method for managing uplink signal quality at a radio node and at a macrocell and/or external cell, includes determining a first transmit power associated with a radio node of a small-cell radio access network and a second transmit power associated with a macrocell and/or an external cell. A desense value associated with an uplink of the radio node of the small-cell radio access network is provided, which enables balancing of a first signal to noise-plus-interference ratio associated with an uplink of the small-cell radio access network and a second signal to noise-plus-interference ratio associated with an uplink of the macrocell and/or external cell in relation to a downlink of the radio node, thereby managing uplink signal quality at the radio node of the small-cell radio access network and at the macrocell and/or external cell.

### FIELD OF INVENTION

The present invention relates generally to the field of wireless communications. More particularly, the present invention relates to facilitating handoff operations in a wireless communication system.

### SUMMARY

In cellular networks, radio nodes, also sometimes referred to as base stations, access points, cells, Node Bs, eNodeBs, and the like, are normally installed and commissioned after a careful upfront planning and survey process, which is followed by extensive post installation optimization efforts to maximize the network performance. Such optimization efforts usually involve a considerable amount of manual intervention that could include “drive testing” using specialized measurement devices to collect data on network performance at a variety of geographical locations. This data is then post-processed and analyzed to effect optimization steps including power adjustments, antenna tilt adjustments and the like.

Such prior planning, installation and post-installation efforts can become cost prohibitive for networks that cover complicated physical spaces spanning multiple floors of a building, including elevator shafts, stairwells, atria and meeting rooms. In addition, expensive planning, installation and post-installation procedures often do not make business sense for small-cell (e.g., local area) networks that are installed and operated relatively inexpensively. In particular, the cost of installation procedures may be prohibitive in enterprise networks that are described herein, as well as applications that relate to high-density capacity enhancements of a downtown city square and ad-hoc deployment of a cellular network such as in military applications. Nevertheless, proper configuration and optimization of an enterprise network is important for enabling efficient utilization of network resources, as well as conducting operations such as handoffs between and within the networks.

The disclosed embodiments relate to methods, devices, and computer program products that facilitate various handoff operations by examining radio frequency (RF) and air-interface issues that are likely to be encountered in user equipment (UE) handovers between a macro network and an enterprise network. In one embodiment, the dynamics of RF signal strength and interference values during handover are examined. The handover operations may be carried out in small-cells for outdoor capacity in-fill within the umbrella of a macro network.

One aspect of the disclosed embodiments relates to a method for managing uplink signal quality at a radio node and at a macrocell and/or external cell. The method includes determining a first transmit power associated with a radio node of a small-cell radio access network and a second transmit power associated with a macrocell and/or an external cell. The method further includes providing a desense value associated with an uplink of the radio node of the small-cell radio access network, wherein the desense value in association with the first and second transmit powers enables balancing of a first signal to noise-plus-interference ratio associated with an uplink of the small-cell radio access network and a second signal to noise-plus-interference ratio associated with an uplink of the macrocell and/or external cell in relation to a downlink of the radio node of the small cell radio access network and a downlink of the macrocell and/or external cell, thereby managing uplink signal quality at the radio node of the small-cell radio access network and at the macrocell and/or external cell.

Another aspect of the disclosed embodiments relates to a device that comprises a processor and a memory that comprises processor executable code. The processor executable code, when executed by the processor, configures the device to a first transmit power associated with a radio node of a small-cell radio access network and a second transmit power associated with a macrocell. The processor executable code, when executed by the processor, further configures the device to provide a desense value associated with an uplink of the radio node of the small-cell radio access network, wherein the desense value in association with the first and second transmit powers enables balancing of a first signal to noise-plus-interference ratio associated with an uplink of the small-cell radio access network and a second signal to noise-plus-interference ratio associated with an uplink of the macrocell and/or external cell in relation to a downlink of the radio node of the small cell radio access network and a downlink of the macrocell and/or external cell, thereby managing uplink signal quality at the radio node of the small-cell radio access network and at the macrocell and/or external cell.

Another aspect of the disclosed embodiments relates to a computer program product, embodied on a computer non-transitory readable medium. The computer readable medium comprises program code for determining a first transmit power associated with a radio node of a small-cell radio access network and a second transmit power associated with a macrocell. The computer readable medium further comprises program code for providing a desense value associated with an uplink of the radio node of the small-cell radio access network, wherein the desense value in association with the first and second transmit powers enables balancing of a first signal to noise-plus-interference ratio associated with an uplink of the small-cell radio access network and a second signal to noise-plus-interference ratio associated with an uplink of the macrocell and/or external cell in relation to a downlink of the radio node of the small cell radio access network and a downlink of the macrocell and/or external cell, thereby managing uplink signal quality at the radio node of the small-cell radio access network and at the macrocell and/or external cell.

In one embodiment, the desense value is determined in accordance with a transmit power of the radio node of the small-cell radio access network, a transmit power of the macrocell and a noise level associated with the macrocell.

One aspect of the disclosed embodiments relates to another method for managing uplink signal quality at a first radio node and at a second radio node. The method includes determining a first transmit power associated with a first radio node of a small-cell radio access network and a second transmit power associated with a second radio node of the small-cell radio access network. The method also includes determining a first desense value associated with an uplink of the first radio node. The method further includes determining a second desense value associated with an uplink of the second radio node, wherein the first and the second desense values enable balancing of a first signal to noise-plus-interference ratio associated with an uplink of the small-cell radio access network and a second signal to noise-plus-interference ratio associated with an uplink of the second radio node in relation to a downlink of the first radio node and a downlink of the second radio node, thereby managing uplink signal quality at the first radio node and the second radio node.

In one embodiment, the first desense value is determined in accordance with a constant desense value, a maximum transmit power of all radio node of the small-cell radio access network and a transmit power of the first radio node. In another embodiment, the second desense value is determined in accordance with a constant desense value, a maximum transmit power of all radio node of the small-cell radio access network and a transmit power of the second radio node.

One aspect of the disclosed embodiments relates to a device that comprises a processor and a memory comprising processor executable code. The processor executable code, when executed by the processor, configures the device to determine a first transmit power associated with a first radio node of a small-cell radio access network and a second transmit power associated with a second radio node of the small-cell radio access network. The processor executable code, when executed by the processor, further configures the device to determine a first desense value associated with the uplink of the first radio node; and determine a second desense value associated with an uplink of the second radio node, wherein the first and the second desense values enable balancing of a first signal to noise-plus-interference ratio associated with an uplink of the small-cell radio access network and a second signal to noise-plus-interference ratio associated with an uplink of the second radio node in relation to a downlink of the first radio node and a downlink of the second radio node, thereby managing uplink signal quality at the first radio node and the second radio node.

Another aspect of the disclosed embodiments relates to a computer program product, embodied on a computer readable medium. The computer program product comprises program code for determining a first transmit power associated with a first radio node of a small-cell radio access network and a second transmit power associated with a second radio node of the small-cell radio access network. The computer program product further comprises program code for determining a first desense value associated with the uplink of the first radio node; and program code for determining a second desense value associated with an uplink of the second radio node, wherein the first and the second desense values enable balancing of a first signal to noise-plus-interference ratio associated with an uplink of the small-cell radio access network and a second signal to noise-plus-interference ratio associated with an uplink of the second radio node in relation to a downlink of the first radio node and a downlink of the second radio node, thereby managing uplink signal quality at the first radio node and the second radio node.

These and other advantages and features of various embodiments of the present invention, together with the organization and manner of operation thereof, will become apparent from the following detailed description when taken in conjunction with the accompanying drawings.

### BRIEF DESCRIPTION OF THE DRAWINGS

Embodiments of the invention are described by referring to the attached drawings, in which:

FIG. 1 illustrates an exemplary network within which the disclosed embodiments can be implemented;

FIG. 2 illustrates an exemplary universal mobile telecommunication system (UMTS) terrestrial radio access network (UTRAN) within which the disclosed embodiments can be implemented;

FIG. 3 illustrates an exemplary small-cell radio access network within which the disclosed embodiments can be implemented;

FIG. 4 illustrates a handoff operation between two radio nodes of a small-cell radio access network in accordance with an example embodiment;

FIG. 5 illustrates a handoff operation between a radio node of a small-cell radio access network and a macrocell in accordance with an example embodiment;

FIG. 6 illustrates an exemplary series of operations that are carried out to facilitate a user equipment handoff in accordance with an example embodiment;

FIG. 7 illustrates another series of operations that are carried out to facilitate a user equipment handoff in accordance with an example embodiment; and

FIG. 8 is a block diagram of an example device for implementing the various disclosed embodiments.

### DETAILED DESCRIPTION OF CERTAIN EMBODIMENTS

In the following description, for purposes of explanation and not limitation, details and descriptions are set forth in order to provide a thorough understanding of the present invention. However, it will be apparent to those skilled in the art that the present invention may be practiced in other embodiments that depart from these details and descriptions.

Additionally, in the subject description, the word “exemplary” is used to mean serving as an example, instance, or illustration. Any embodiment or design described herein as “exemplary” is not necessarily to be construed as preferred or advantageous over other embodiments or designs. Rather, use of the word exemplary is intended to present concepts in a concrete manner. Further, some of the disclosed embodiments are described in the context of an enterprise network. However, it should be understood that the disclosed concepts are equally applicable to other types of networks.

The disclosed embodiments facilitate various types of handoff operations. A handoff, which is sometimes referred to as a handover, refers to the transfer of an ongoing communication session (e.g., a voice or data session) from one radio link to another radio link. The transfer of the on-going session can be to another network (e.g., to a network with a different radio access technology (RAT) or an inter-RAT handoff), to another cell, to another sector of the same cell, to another frequency within the same cell and the like. Additionally, or alternatively, the various handoff scenarios may be described in terms of inter-frequency and intra-frequency handoff operations. Inter-frequency handoff refers to adding a radio link for service to the user equipment on a different logical entity which uses a different channel frequency, such as a neighboring cell operating on a different frequency. Inter-frequency handoff can, but does not necessarily, include terminating the radio link on the source cell (i.e., a hard handoff that is described in sections that follow). Intra-frequency handoff refers to adding a radio link on a different logical entity which uses the same channel frequency. Further, the term “cell” may be construed in different ways. For example, a cell can be considered a logical entity that manages a single radio channel (i.e., the typical definition in the context of Universal Mobile Telecommunications System (UMTS)). In other examples, a cell may be considered a logical entity that manages multiple radio channels, usually on different frequencies. In still other examples, a cell may can be construed as a logical entity that manages multiple radio channels, on the same or different frequencies, that have been sectorized. In other scenarios, a cell can be considered a physical area covered adequately by RF energy from a particular sector of a physical base station installation, which can include just one RF channel or multiple RF channels. In yet other examples, a cell can be construed as a physical area covered adequately by RF energy from all sectors of a physical base station installation, which can also include one or multiple RF channels.

The disclosed embodiments also facilitate different types of handoffs that are known as hard, soft and softer handoffs. In a hard handoff, the connection to the existing radio link is broken before the connection to the new radio link is established. In a soft handoff, the existing radio link is retained and used in parallel with one or more newly acquired radio links of the target cell(s). The simultaneous connections in a soft handoff may be for a brief or substantial period of time. A softer handoff, which is used in Universal Mobile Telecommunications System (UMTS), is a special case of a soft handoff, where the radio links that are used in parallel belong to the same Node B.

A handoff can be initiated for a variety of reasons. For example, a user equipment that moves to another geographical area, which is outside of the coverage area of its existing cell, may initiate a handoff to avoid termination of the on-going session. In another example, a handoff to another cell may be initiated to free up resources at an existing cell. In yet another example, a handoff is used to improve interference from other channels. In order to initiate a handoff, the user equipment must be aware of potential target cells (i.e., neighboring radio nodes) that are likely to accommodate the handoff. The information regarding the neighboring radio nodes can be provided in a listing that is often referred to a neighbor list. In the context of an enterprise network, neighbor radio nodes may include both radio nodes that are internal to the enterprise network and the ones that operate outside of the enterprise network.

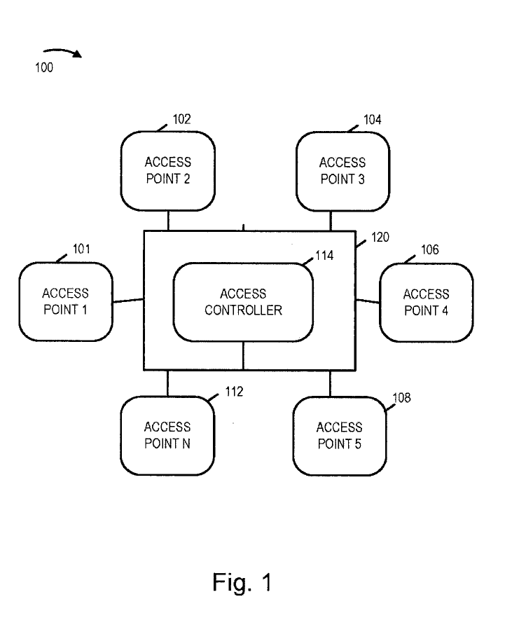

FIG. 1 illustrates an exemplary system 100 which may be used to accommodate some or all of the disclosed embodiments. The system 100 can, for example, be a small-cell radio network, an enterprise network, and the like. The system 100 includes a plurality of access points referenced as 101, 102, 104, 106, 108 and 112. The access points that are illustrated in FIG. 1 are connected, directly or indirectly, to an access controller 114 through connection 120. Each of the access points 101, 102, 104, 106, 108 and 112 is herein referred to as an “internal access point” (or an “internal radio node”). Each internal access point may communicate with a plurality of user equipment (UE), as well as other access points. It should be noted that while FIG. 1 illustrates a single central controller 114 that is distinct from the access points, it is also possible that the access controller is implemented as part of one or more access points. Further, the various embodiments of the present invention may also be implemented using a peer-to-peer network of access points, where each access point can initiate certain transmissions, including commands and/or data, to other access points without the involvement of a central controller.

The exemplary block diagram that is shown in FIG. 1 is representative of a single network that may be adjacent to, or partially overlapping with, other networks. The collection of these other networks, which may comprise macro-cellular networks, femtocell networks and the like, are herein referred to as the external networks. Each “external network” may comprise one or more access controllers and a plurality of “external access points” (or “external radio nodes”).

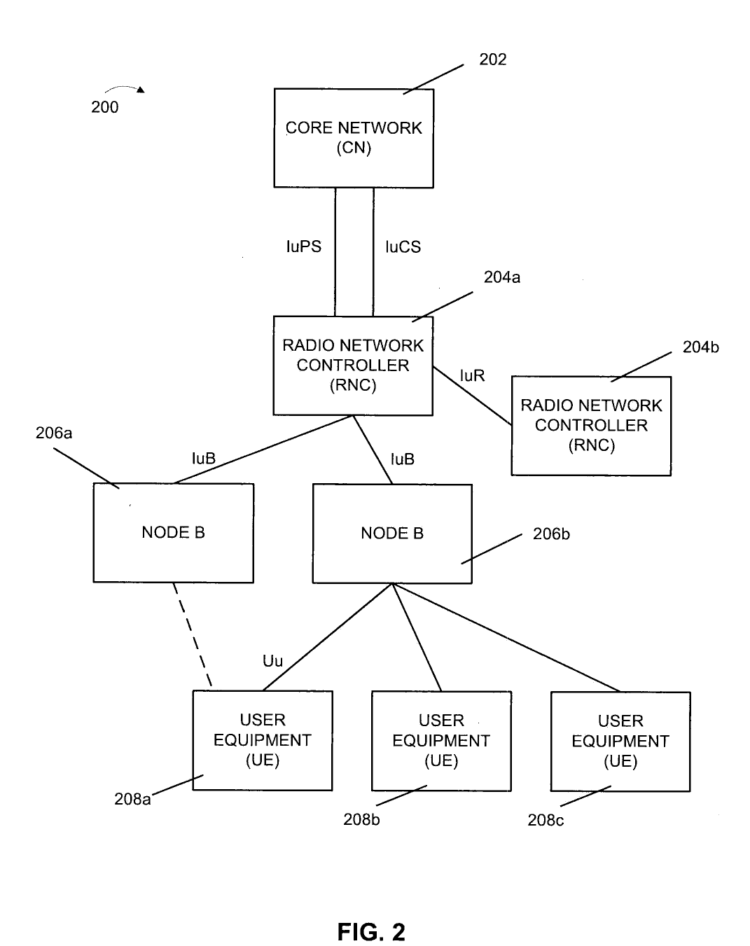

FIG. 2 is another exemplary diagram of a radio network 200, such as a Universal Mobile Telecommunication System (UMTS) Terrestrial Radio Access Network (UTRAN), that can accommodate the various disclosed embodiments. The network that is depicted in FIG. 2 comprises a Core Network (CN) 202, one or more Radio Network Controllers (RNC) 204a that are in communication with a plurality of Node Bs 206a and 206b (or base stations or radio nodes) and other RNCs 202b. Each Node B 206a, 206b is in communication with one or more UEs 208a, 208b and 208c. There is one serving cell controlling the serving radio link assigned to each UE 208a, 208b and 208c. However, as illustrated in FIG. 2 with a dashed line, a UE 208a may be in communication with more than one Node B. For example, a Node B of a neighboring cell may communicate with one or more UEs of the current cell during handoffs and/or to provide overload indications. While FIG. 2 depicts an exemplary radio network in a UMTS system, the disclosed embodiments may be extended to operate with other systems and networks such as CDMA2000, WiMAX, LTE and the like.

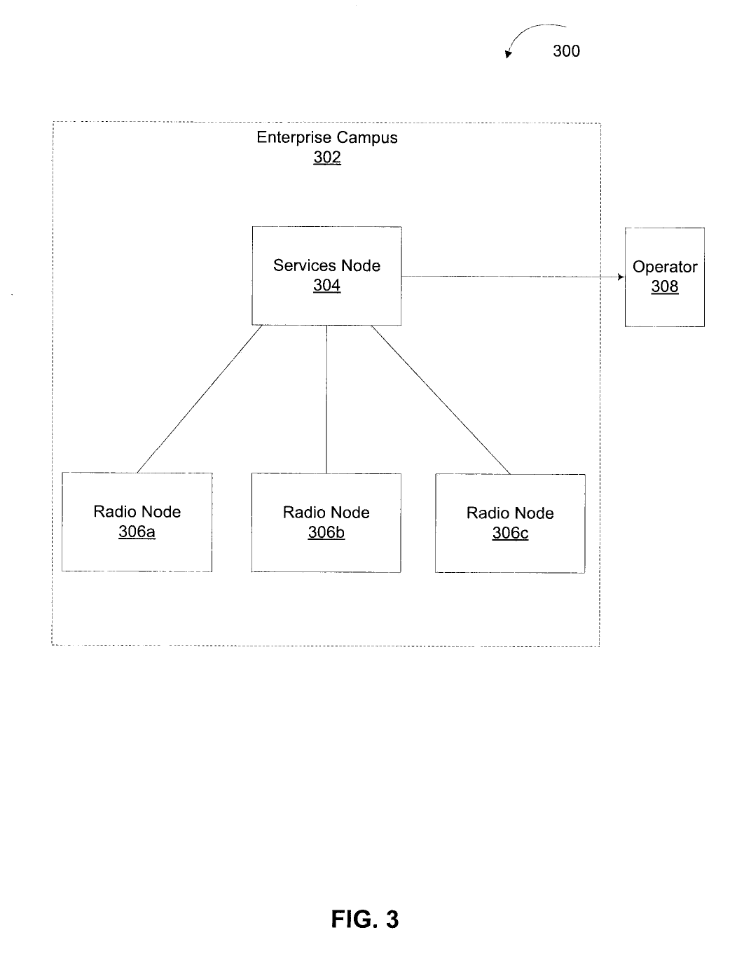

FIG. 3 illustrates an exemplary Enterprise Radio Access Network (E-RAN) 300 that can be used to accommodate the various disclosed embodiments. The E-RAN 300, which is an example of a small-cell radio network includes a services node 304 and a plurality of radio nodes 306a, 306b and 306c. It should be noted that the E-RAN 300 can include fewer or additional radio nodes and/or additional services nodes. The services node 304 is the central control point of the overall cluster of radio nodes 306a, 306b and 306c that are deployed throughout the enterprise campus 302. The services node 304, which can be deployed inside the enterprise local area network (LAN) provides, for example, session management for all mobile sessions delivered by the radio nodes 306a, 306b and 306c. Each of the radio nodes 306a, 306b and 306c is in communication with one or more UEs (not depicted). The radio nodes 306a, 306b and 306c can support a multi-radio architecture that allows a flexible upgrade path to higher user counts, as well as the ability to support different radio access technologies. In one example, the E-RAN 300 configuration allows the creation of a unified mobile corporate network that integrates mobile workers distributed throughout the overall enterprise domain with centrally located corporate assets. FIG. 3 also illustrates an operator 308 that is in communication with the services node 304, which can monitor the operations of the services node 304 and can provide various input and control parameters to the services node 304. The interactivity between the operator 308 and the services node 304 can be provided through, for example, a command line interface (CLI) and/or industry-standard device configuration protocols, such as TR-69 or TR-196.

It should be noted that while the exemplary radio networks that are depicted in FIGS. 1-3 all include a central controller, the disclosed embodiments are equally applicable to non-centralized network architectures. Such architectures can, for example, comprise isolated home Node Bs, radio nodes and/or a femtocell-based enterprise deployments that do not use a central controller.

It should be also noted that in some embodiments a handoff operation may be more specifically described by using the terms “hand-in” and “hand-out.” A hand-in operation is associated with receiving an on-going session that is transferred into the current network from an external network, while a hand-out operation is associated with the transfer of an on-going session out from the current network to an external network.

The following is a listing of signal, noise and interference quantities that may be used to describe the handoff dynamics that are described in connection with the disclosed embodiments.

| Quantity | Description |
|---|---|
| P_{T.M} | Common Pilot Channel (CPICH) transmit power from the |
| | macrocell, typically 28 to 33 dBM (usually 10 dB below |
| | total transmit power for a node B) |
| P_{T.S} | CPICH transmit power from a radio node, typically −10 |
| | to +10 dBm (set to 10 dB below total node transmit power) |
| P_{R, M} | Macrocell CPICH receive power, measured at the UE |
| P_{R, S} | Internal radio node receive power measured at the UE |
| P_{T}^{UL} | Transmit power of the UE, typically limited to a maximum of |
| | 23 dBm |
| P_{R, M}^{UL} | Uplink receive power at the macrocell receiver due to the |
| | UE's transmission |
| P_{R, S}^{UL} | Uplink receive power at the internal radio node receiver due |
| | to the UE's transmission |
| N_{M} | Noise variance at the macrocell uplink receiver |
| N_{S} | Noise variance at the Internal radio node uplink receiver |
| σ_{d}² | Variance of the injected de-sense noise in the internal radio |
| | node uplink receiver |
| SIR_{M} | Uplink signal to noise and interference ratio corresponding |
| | to the UE transmission at the macrocell receiver |
| SIR_{S} | Uplink signal to noise and interference ratio (SIR) |
| | corresponding to the UE transmission at the internal radio |
| | node receiver |
| P_{L} | Path loss between the UE and a transmitter (macro or |
| | internal radio node), assumed symmetric in uplink and |
| | downlink |
| G | Antenna Gain |

In the disclosed embodiments, the listed quantities are presented in logarithmic domain to enable a linear analysis, thereby facilitating the understanding of the underlying concepts. However, it is understood that the disclosed embodiments can be similarly developed in a non-logarithmic domain.

One of the aspects of the disclosed embodiments relates to uplink de-sense mechanisms within the internal network and signal transients during soft-handover. In some embodiments, an enterprise network (such as the network depicted in FIG. 3) can employ a de-sense mechanism within the small-cell radio access network to protect the uplink receiver from UEs that may be placed too close to the radio node. Unlike conventional macro networks, this may not be a rare scenario in indoor deployments, where the radio nodes are typically placed within a few meters of UEs. Under normal conditions, an inner-loop power control mechanism will ensure that a UE transmits the minimum power required to achieve a target signal to noise plus interference ratio (SIR). If the signal is stronger than required to meet the target SIR (SIR_{tgt}), the base station sends “downs” on the power control loop, thereby lowering the UE's signal power. However, most commercial devices have lower limits to their transmit power. By way of example and not by way of limitation, a lower limit on the transmit power is in the neighborhood of −50 dBm. Of course, other values are possilble, while remaining within the spirit and scope of the invention. When a UE is placed too close to the base station receiver, its uplink transmit power, P_{T}^{UL} may rail against a minimum allowed power, P_{T,min}^{UL}. In such a scenario, the uplink SIR will exceed SIR_{tgt} and result in uplink instability for other sessions on the cell due to the non-orthogonal nature of CDMA.

The disclosed embodiments mitigate this problem by injecting white noise to desensitize the receiver. Injecting noise with a variance of σ_{d}² is equivalent to increasing the uplink path loss between the UE and the radio node by the same amount. Therefore, a careful choice of σ_{d}² ensures that a UE is always in power-controllable range, preventing it from railing against its minimum transmit power P_{T,min}^{UL}. This injected noise is hereinafter referred to as “desense” for convenience.

It is important to note that the downlink path loss is not affected in any way by the addition of de-sense noise. Also note that UE's are not expected to be power limited in small-cell networks, such as the E-RAN that is depicted in FIG. 3, and hence de-sense noise (up to a certain level) may safely be injected in the uplink. The addition of desense with the same variance for all radio nodes within the small-cell radio access network would result in a displacement of uplink and downlink cell boundaries as not every radio node transmits with the same downlink power. Therefore, each radio node has a specific value of desense variance, adjusted by using a constant desense value as a base (to combat the near UE problem) and adding the difference between the transmit power of that node and the maximum transmit power across all nodes (to equalize uplink and downlink cell boundaries for all cells). Mathematically, the determination of desense for each radio node, i, of the small-cell radio access network can be represented by:

σ_{d,i}²=σ_{d}²+(maxⱼ(P_{T,S,j})−P_{T,S,i}) (Eq. 1).

In Equation (1), maxⱼ(P_{T,S,j}) represents the maximum transmit power across all radio nodes of the small-cell radio access network. The effective noise floor for a radio node of the small-cell radio access network is then given by:

N_{S,i}^{eff}=10·log₁₀(lin(N_{S,i})+lin(σ_{d,i}²)) (Eq. 1a).

In Equation (1a), lin(x)=10^{0.1(x)} represents conversion of a logarithmic quantity to a linear quantity. Since the additive de-sense noise is typically much greater than the noise floor (i.e., σ_{d,i}²>>N_{S,i}), the effective noise is essentially the same as the injected de-sense value, as expressed by the following:

N_{S,i}^{eff}≈σ_{d,i}² (Eq. 1b).

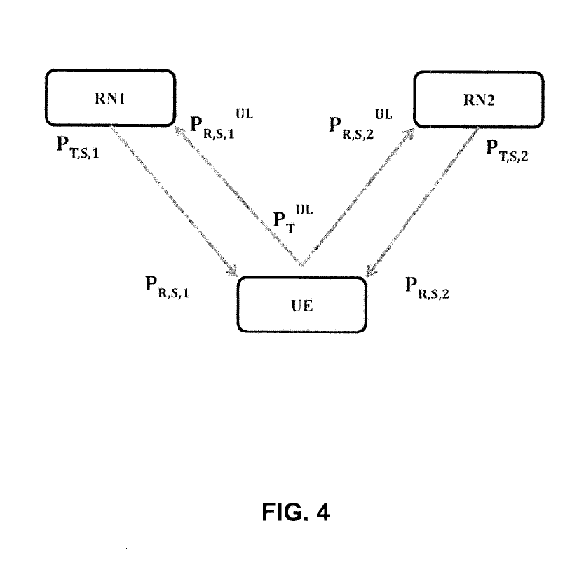

Apart from serving to control interference from a near user, the injected de-sense may be used to balance uplinks in a handover situation. One aspect of the disclosed embodiments relates to signal transients during a handoff within the small-cell radio access network. While the following operations are described in the context of a soft handoff, it is understood that the disclosed embodiments are also applicable to other types of handoff, such a hard handoffs. FIG. 4 illustrates the signal dynamics for a UE that is in soft-handover within the ERAN. Only two cells are illustrated in FIG. 4 for economy of description, but it is understood that disclosed embodiments are equally applicable to scenarios where more cells are present.

In the following, downlink signal dynamics with reference to FIG. 4 is analyzed. Assuming that the two radio nodes have different CPICH transmit powers, P_{T,S,1} and P_{T,S,2′} for a given antenna gains, G₁ and G₂, the corresponding downlink CPICH receive powers at the UE are given by:

P_{R,S,i}=P_{T,S,i}+Gᵢ−P_{L,i′}for i=1,2 (Eq. 2).

The difference in the downlink received CPICH powers is:

(P_{R,S,1}−P_{R,S,2})=(P_{T,S,1}−P_{T,S,2})+(G₁−G₂)−(P_{L,1}−P_{L,2}) (Eq. 3).

At the ideal handover point i.e., assuming no hysteresis or bias and zero signaling delay, the received CPICH powers are equal. This is because the measurements of CPICH related quantities (RSCP or Ec/No) are typically used as handoff decision triggers. This naturally implies that the ideal handoff point is reached when the difference in path losses is equal to the difference in CPICH transmit powers. In other words, the ideal handoff is reached when:

(P_{T,S,1}−P_{T,S,2})+(G₁−G₂)=(P_{L,1}−P_{L,2}) (Eq. 4).

With reference to FIG. 4, the following analyzes uplink signal dynamics at the handoff point. The UE transmits an uplink power P_{T}^{UL} which, after attenuation by the path loss, is received at each base station receiver as:

P_{R,S,i}^{UL}=P_{T}^{UL}+Gᵢ−P_{L,i′} for i=1,2 (Eq. 5).

The quantity of interest in the uplink is the signal-to-noise plus interference ratio (SIR), which determines power control behavior and session stability. The following analysis assumes the calculation of SIR ratios at the chip-level rather than the symbol level, effectively ignoring the spreading factor of the waveform and the associated processing gain. On a particular radio node ‘i’, of the small-cell radio access network, the SIR is given by Equations (1a) and 1(b). Therefore, the SIR is given by the ratio of the received signal power to the sum of thermal and injected desense noise. Assuming that the sum of thermal and injected desense noise can be approximated by just the de-sense noise, SIR for radio node i can be determined as:

SIRᵢ=P_{R,S,i}^{UL}−σ_{d,i}² (Eq. 6).

The difference in the signal-to-noise ratios is given by:

(SIR₁−SIR₂)=(G₁−G₂)+(P_{L,2}−P_{L,1})−(σ_{d,1}²−σ_{d,2}²) (Eq. 7).

Since the difference in path loss ratios at the ideal handover point is equal to the difference in downlink CPICH transmit powers adjusted by the antenna gains (see Equation (4)), Equation (7) may be recast as:

(SIR₁−SIR₂)=(P_{T,S,2}−P_{T,S,1})−(σ_{d,1}²−σ_{d,2}²) (Eq. 8).

By suitably choosing the variance of injected noise to be related to the transmit power, as described in Equation (1), and substituting this value in Equation (8), an uplink SIR balance at the ideal handover point can be achieved. Therefore, both downlinks and uplinks are balanced at this point. From a practical perspective, the above-described balancing of the downlinks and uplinks is straightforward with a centralized architecture due to the computation of Equation (1). In a distributed architecture with direct connections between the radio nodes, the above-described operations may be carried out through cooperation of the multiple nodes.

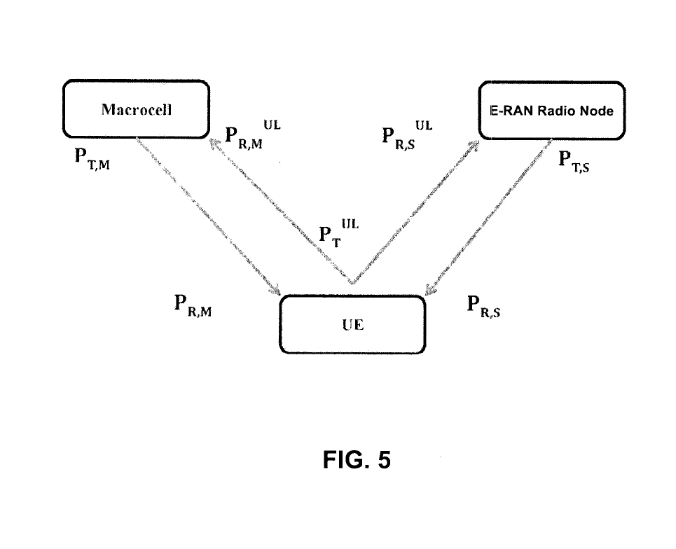

Another aspect of the disclosed embodiments relates signal dynamics in handoffs between a macrocell (e.g., a cell external to the small-cell radio network) and a radio node of a small-cell radio access network, such as the exemplary E-RAN that is depicted in FIG. 3. FIG. 5 illustrates the scenario in which a UE is in handoff between the macrocell/external cell and a radio node of the small-cell radio access network. For simplicity, the following operations are described in the context of a hard handoff, although these operations may be extended to carry out a soft-handoff, as well. It is important to note that in soft-handoff scenarios, it is critical to balance both downlink and uplink to ensure that the serving cell can power control the uplink.

Assuming, once again, that the ideal handoff point as that location at which the downlink received CPICH measurements are equal, the following relationship, analogous to the one expressed by Equation (4), can be developed for downlink:

(P_{T,M}−P_{T,S})+(G_{M}−G_{S})=(P_{L,M}−P_{L,S}) (Eq. 9).

In Equation (9), the subscripts M and S correspond to the macrocell and the small-cell radio access network, respectively. It is uncommon for macrocells to use any level of desense, as the goal is often to maximize link budget, not to compromise it. Therefore, the noise floor at the macrocellis assumed to be N_{M} and σ_{d,m}² is assumed to be zero. Examination of the uplink SIR at this point, in line with the analysis discussed in connection with Equations (5)-(8), yields the following equation:

(SIR_{M}−SIR_{S})=(P_{T,S}−P_{T,M})−(N_{M}−σ_{d,S}²) (Eq. 10).

It is evident from Equation (10) that uplink SIRS at the macrocell and the radio node of the small-cell radio access network may be balanced at the ideal handoff point with an appropriate choice of the desense noise level, σ_{d,S}², at the radio node of the small-cell radio access network, according to the following equation:

σ_{d,S}²=(P_{T,M}−P_{T,S})+N_{M} (Eq. 11).

It is evident from Equation (11), that through the exchange of information, such as N_{M} between the small-cell radio network and the macrocell, a proper value of the desense can be determined to balance the SIRs for handoff purposes. Furthermore, the change in desense level due to knowledge of the macro network, as compared to the internal value computed in the small-cell radio access network (i.e., using Equation (1)), may be applied uniformly through the small-cell radio access network due to the small-cell RF management suite that resides, for example, on a centralized controller.

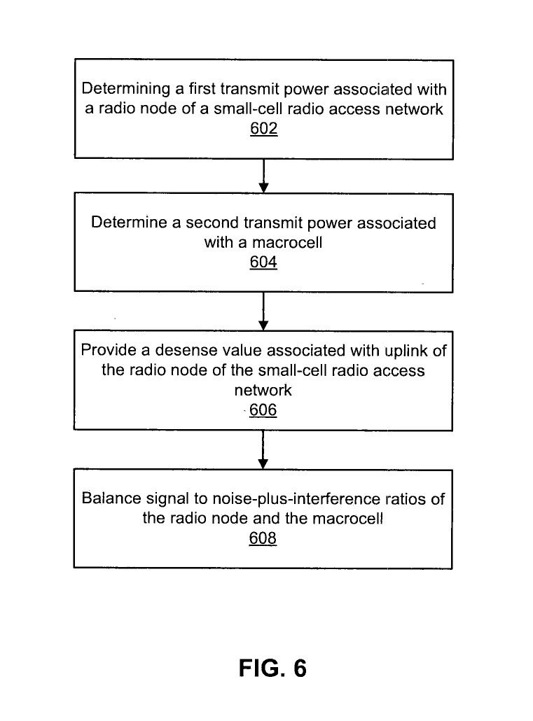

FIG. 6 illustrates a series of operations that are carried out to facilitate handoffs between a radio node of an small-cell radio access network and a macrocell according to an exemplary embodiment. At 602, a first transmit power associated with a radio node of the small-cell radio access network is determined. At 604, a second transmit power associated with the macrocell is determined. At 606, a desense value associated with uplink of the radio node of the small-cell radio access network is provided. In one embodiment, the value of desense is determined according to Equation (11). At 606, the signal to noise-plus-interference ratios associated with the radio node and the macrocell are balanced when the desense value is implemented by the radio node. Such a determination of the desense value can be accomplished through the exchange of information between the macrocell and the small-cell radio access network. The exchanged information can include, but is not limited to, a noise floor associated with the macrocell. In other examples, the small-cell radio network determines the value of P_{T,M} since it is transmitted in broadcast channels by the macro network. The determination of P_{T,M} can be accomplished through RF management “network listen” operations, but is typically not done by the macrocellular network. In other examples, the small-cell (or its controller) then queries a networking element that sits within the operator core network and which can communicate with the macro network RNC or nodeB to determine the value of N_{M}. In still other examples, the small-cell (or its controller) may alternatively look up a pre-defined database that has been pre-populated with the value of N_{M} for the macrocell that it has just identified through network listen operations.

In still other embodiments, the macro network could specifically inform the small-cell network of an impending handover into the small-cell network so that the de-sense value can be increased only when necessary to facilitate link balancing upon hand-in. This could be done by slowly ramping de-sense across the small-cell radio network so as to not de-stabilize existing connections and allowing power control loops to keep up. In one example, the de-sense value is lowered again following the completion of the hand-in operation.

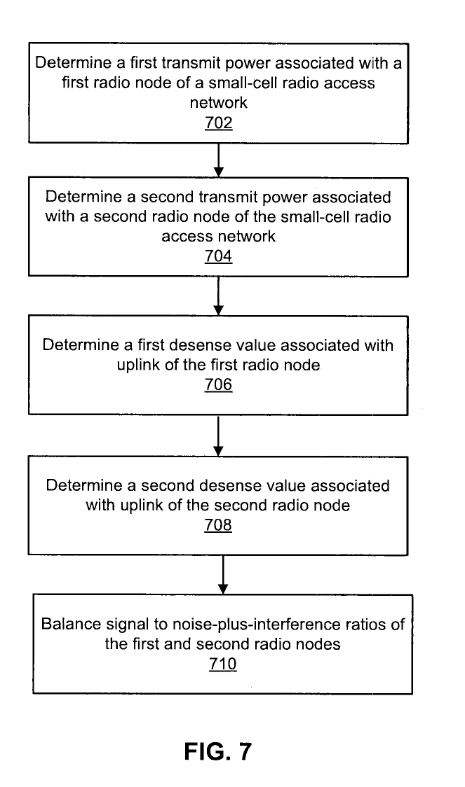

FIG. 7 illustrates a series of operations that are carried out to facilitate handoff between a first radio node of a small-cell radio access network and a second radio node of the small-cell radio access network according to an exemplary embodiment. At 702, a first transmit power associated with a first radio node of the small-cell radio access network is determined. At 704, a second transmit power associated with a second radio node of the small-cell radio access network is determined. At 706, a first desense value associated with uplink of the first radio node is determined, and at 708, a second desense value associated with uplink of the second radio node is determined. At 710, the signal to noise-plus-interference ratios of the first and second radio nodes are balanced, thereby facilitating a handoff between the first and the second radio nodes. The determination of the first and the second desense values can be facilitated by the exchange and/or sharing of information between the first and the second radio nodes of the small-cell radio access network. This information can correspond to the one or more parameters that are provided in Equation (11).

In other embodiments, handoff operations between adjacent small-cell networks can be facilitated through operations that are similar to those discussed in connection with FIGS. 6 and 7. In one example, each of small-cell networks is deployed in a somewhat ad-hoc manner, without careful planning and optimization.

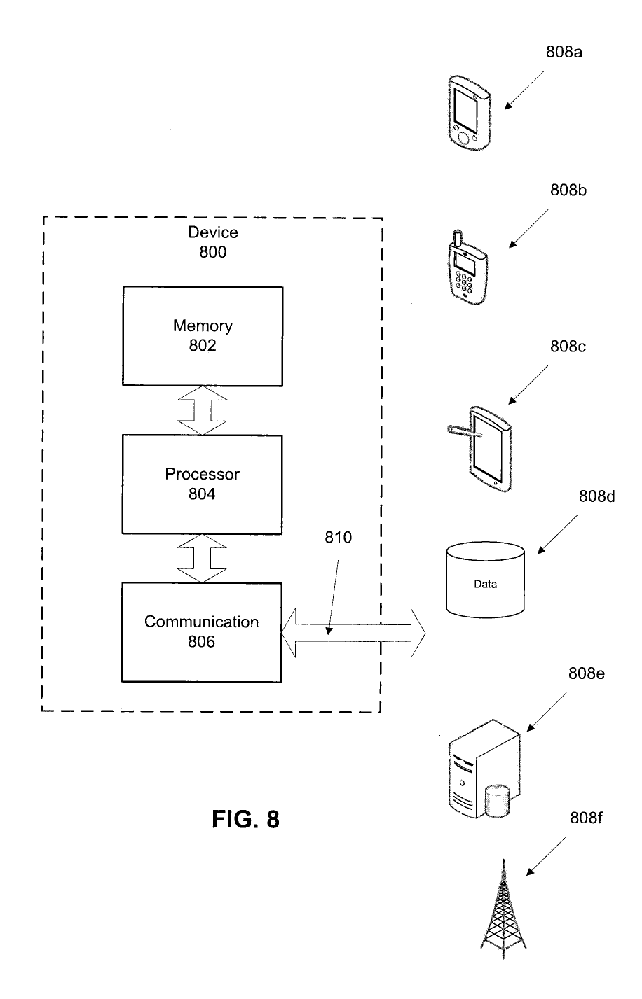

It is understood that the various embodiments of the present invention may be implemented individually, or collectively, in devices comprised of various hardware and/or software modules and components. These devices, for example, may comprise a processor, a memory unit, an interface that are communicatively connected to each other, and may range from desktop and/or laptop computers, to consumer electronic devices such as media players, mobile devices and the like. For example, FIG. 8 illustrates a block diagram of a device 800 within which the various embodiments of the present invention may be implemented. The device 800 comprises at least one processor 802 and/or controller, at least one memory 804 unit that is in communication with the processor 802, and at least one communication unit 806 that enables the exchange of data and information, directly or indirectly, with other entities, devices and networks 808a to 808f. For example, the device 800 may be in communication with mobile devices 808a, 808b, 808c, with a database 808d, a sever 808e and a radio node 808f. The communication unit 806 may provide wired and/or wireless communication capabilities, through communication link 810, in accordance with one or more communication protocols and, therefore, it may comprise the proper transmitter/receiver antennas, circuitry and ports, as well as the encoding/decoding capabilities that may be necessary for proper transmission and/or reception of data and other information. The exemplary device 800 that is depicted in FIG. 8 may be integrated as part of the various entities that are depicted in FIGS. 1-3, including an access controller 114, an access point 101, 102, 104, 106, 108 and 112, a radio node controller 204a and 204b, a Node B 206a and 206b, a user equipment 208a, 208b and 208c, a services node 304 and/or a radio node 306a, 306b and 306c. The device 800 that is depicted in FIG. 8 may reside as a separate component within or outside the above-noted entities that are depicted in FIGS. 1-3.

The various components or sub-components within each module of the disclosed embodiments may be implemented in software, hardware, firmware. The connectivity between the modules and/or components within the modules may be provided using any one of the connectivity methods and media that is known in the art, including, but not limited to, communications over the Internet, wired, or wireless networks using the appropriate protocols.

Various embodiments described herein are described in the general context of methods or processes, such as the processes described in FIGS. 6 and 7 of the present application. It should be noted that processes that are described in FIGS. 6 and 7 may comprise additional or fewer steps. For example, two or more steps may be combined together. The disclosed methods may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Therefore, the disclosed embodiments can be implemented as computer program products that reside on a non-transitory computer-readable medium. Generally, program modules may include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

The foregoing description of embodiments has been presented for purposes of illustration and description. The foregoing description is not intended to be exhaustive or to limit embodiments of the present invention to the precise form disclosed, and modifications and variations are possible in light of the above teachings or may be acquired from practice of various embodiments. For example, the disclosed embodiments are equally applicable to networks that utilize different communication technologies, including but not limited to UMTS (including R99 and all high-speed packet access (HSPA) variants), as well as LTE, WiMAX, GSM and the like. The embodiments discussed herein were chosen and described in order to explain the principles and the nature of various embodiments and its practical application to enable one skilled in the art to utilize the present invention in various embodiments and with various modifications as are suited to the particular use contemplated. The features of the embodiments described herein may be combined in all possible combinations of methods, apparatus, modules, systems, and computer program products.

What is claimed is:

1. A method for managing uplink signal quality at a radio node and at a macrocell and/or external cell, comprising:
determining a first transmit power associated with a radio node of a small-cell radio access network and a second transmit power associated with a macrocell and/or an external cell; and
providing a desense value associated with an uplink of the radio node of the small-cell radio access network, wherein the desense value in association with the first and second transmit powers enables balancing of a first signal to noise-plus-interference ratio associated with an uplink of the small-cell radio access network and a second signal to noise-plus-interference ratio associated with an uplink of the macrocell and/or external cell in relation to a downlink of the radio node of the small cell radio access network and a downlink of the macrocell and/or external cell, thereby managing uplink signal quality at the radio node of the small-cell radio access network and at the macrocell and/or external cell.

2. A device, comprising:
a processor; and
a memory comprising processor executable code, the processor executable code, when executed by the processor, configures the device to:
determine a first transmit power associated with a radio node of a small-cell radio access network and a second transmit power associated with a macrocell and/or an external cell; and
provide a desense value associated with an uplink of the radio node of the small-cell radio access network, wherein the desense value in association with the first and second transmit powers enables balancing of a first signal to noise-plus-interference ratio associated with an uplink of the small-cell radio access network and a second signal to noise-plus-interference ratio associated with an uplink of the macrocell and/or external cell in relation to a downlink of the radio node of the small cell radio access network and a downlink of the macrocell and/or external cell, thereby managing uplink signal quality at the radio node of the small-cell radio access network and at the macrocell and/or external cell.

3. A computer program product, embodied on a computer readable medium, comprising:
program code for determining a first transmit power associated with a radio node of a small-cell radio access network and a second transmit power associated with a macrocell and/or an external cell; and
program code for providing a desense value associated with an uplink of the radio node of the small-cell radio access network, wherein the desense value in association with the first and second transmit powers enables balancing of a first signal to noise-plus-interference ratio associated with an uplink of the small-cell radio access network and a second signal to noise-plus-interference ratio associated with an uplink of the macrocell and/or external cell in relation to a downlink of the radio node of the small cell radio access network and a downlink of the macrocell and/or external cell, thereby managing uplink signal quality at the radio node of the small-cell radio access network and at the macrocell and/or external cell.

4. The method of claim 1, wherein the desense value is determined in accordance with a transmit power of the radio node of the small-cell radio access network, a transmit power of the macrocell and/or external cell and a noise level associated with the macrocell and/or external cell.

5. A method for managing uplink signal quality at a first radio node and at a second radio node, comprising:
determining a first transmit power associated with a first radio node of a small-cell radio access network and a second transmit power associated with a second radio node of the small-cell radio access network;
determining a first desense value associated with an uplink of the first radio node; and
determining a second desense value associated with an uplink of the second radio node, wherein the first and the second desense values enable balancing of a first signal to noise-plus-interference ratio associated with an uplink of the small-cell radio access network and a second signal to noise-plus-interference ratio associated with an uplink of the second radio node in relation to a downlink of the first radio node and a downlink of the second radio node, thereby managing uplink signal quality at the first radio node and the second radio node.

6. A device, comprising:
a processor; and
a memory comprising processor executable code, the processor executable code, when executed by the processor, configures the device to:
determine a first transmit power associated with a first radio node of a small-cell radio access network and a second transmit power associated with a second radio node of the small-cell radio access network;
determine a first desense value associated with uplink of the first radio node; and
determine a second desense value associated with an uplink of the second radio node, wherein the first and the second desense values enable balancing of a first signal to noise-plus-interference ratio associated with an uplink of the small-cell radio access network and a second signal to noise-plus-interference ratio associated with an uplink of the second radio node in relation to a downlink of the first radio node and a downlink of the second radio node, thereby managing uplink signal quality at the first radio node and the second radio node.

7. A computer program product, embodied on a computer readable medium, comprising:
program code for determining a first transmit power associated with a first radio node of a small-cell radio access network and a second transmit power associated with a second radio node of the small-cell radio access network;
program code for determining a first desense value associated with the uplink of the first radio node; and
program code for determining a second desense value associated with an uplink of the second radio node, wherein the first and the second desense values enable balancing of a first signal to noise-plus-interference ratio associated with an uplink of the small-cell radio access network and a second signal to noise-plus-interference ratio associated with an uplink of the second radio node in relation to a downlink of the first radio node and a downlink of the second radio node, thereby managing uplink signal quality at the first radio node and the second radio node.

8. The method of claim 5, wherein the first desense value is determined in accordance with a constant desense value, a maximum transmit power of all radio node of the small-cell radio access network and a transmit power of the first radio node.

9. The method of claim 1, wherein the providing comprises:
applying the desense value to a signal received by the radio node of the small-cell radio access network prior to demodulation of the signal.

10. The method of claim 1, further comprising:
providing the desense value from the small-cell radio access network to the macrocell and/or external cell by exchange of information there between.

11. The method of claim 4, further comprising:
providing the noise level associated with macrocell and/or external cell to the small-cell radio access network by exchange of information there between.

12. The method of claim 1, further comprising:
notifying, by the macrocell and/or external cell, of an impending handover into the small-cell radio access network; and
changing the desense value as necessary to facilitate link balancing upon handover into the small-cell radio access network.

13. The method of claim 12, wherein the changing the desense value comprises:
slowly ramping de-sense value across the small-cell radio access network so as to not de-stabilize existing connections; and
reverting the de-sense value following the completion of the handover into the small-cell radio access network.

14. The method of claim 1, further comprising:
determining upon impending handout from the small-cell radio access network into the macrocell and/or external cell;
changing the desense value as necessary to facilitate link balancing upon handout from the small-cell radio access network.

15. The device of claim 2, wherein the desense value is determined in accordance with a transmit power of the radio node of the small-cell radio access network, a transmit power of the macrocell and/or external cell and a noise level associated with the macrocell and/or external cell.

16. The device of claim 2, the processor executable code, when executed by the processor, further configures the device to:
apply the desense value to a signal received by the radio node of the small-cell radio access network prior to demodulation of the signal.

17. The device of claim 2, the processor executable code, when executed by the processor, further configures the device to:
provide the desense value from the small-cell radio access network to the macrocell and/or external cell by exchange of information there between.

18. The device of claim 15, the processor executable code, when executed by the processor, further configures the device to:
provide the noise level associated with macrocell and/or external cell to the small-cell radio access network by exchange of information there between.

19. The device of claim 2, the processor executable code, when executed by the processor, further configures the device to:
notify of an impending handover into the small-cell radio access network; and
change the desense value as necessary to facilitate link balancing upon handover into the small-cell radio access network.

20. The device of claim 19, wherein the change the desense value comprises:
slowly ramp de-sense value across the small-cell radio access network so as to not de-stabilize existing connections; and
revert the de-sense value following the completion of the handover into the small-cell radio access network.
